(19) United States
(12) Patent Application Publication
(10) Pub. No.: US 2008/0294639 A1
(43) Pub. Date: Nov. 27, 2008

(54) System and Method For Delegating Program Management Authority

(75) Inventors: Todd Davis, Chandler, AZ (US); Jennifer Anne Lennon, Phoenix, AZ (US); Williamette Kehau Ritscher, Phoenix, AZ (US); Jane H. C. Thompson, Ontario (CA); Keith D. Weber, Richmond, TX (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 11/751,165

(22) Filed: May 21, 2007

(51) Int. Cl. G06F 17/30

(52) U.S. Cl. 707/9

(57) ABSTRACT

A system and method for managing authority granted to third parties to act on the behalf of an organization is disclosed. The system enables program administrators to request authority to manage one or more programs and/or products. A request for authority is submitted to an authorized officer for the organization that the program administrator wishes to act on behalf of. The authorizing office may approve or decline the request as well as assign specific permissions relating to one of more programs and/or product. The system further includes a contact management system providing reporting and hierarchical analysis features relating to program administrators, authorizing officers, account development managers.

### FIELD OF THE INVENTION

The invention generally relates to a system for configuring and delegating management authority to individuals both within and outside of an organization, and more particularly, to a system and method for providing access to financial management systems for managing charge card related programs.

### BACKGROUND OF THE INVENTION

Delegation of authority is essential to the effective administration of an organization. Generally, any employee or designated third-party is afforded a level of trust or authority within an organization in order to perform assigned roles, whether custodial or administrative in nature. For example, a custodian would generally be provided authority to order supplies needed for the upkeep of a corporation's office space, while an accountant is provided authority to issue checks to company suppliers and service vendors. Regardless of the level of authority given to an employee or designated third-party, management of that authority and accountability are essential to the efficient operations of an organization.

A number of commercial and proprietary software tools have been developed to help organizations manage employees and employee roles. Companies often use simple databases to record information relating to an employee for use by Human Resources, Payroll, and Management. More complex systems enable organizations to record information relating to an employee's duties and responsibilities, performance expectations, performance reviews, and the like. As such, an employee is able to perform designated functions for the corporation in accordance with the recorded duties and responsibilities.

Many employee tasks within a modern organization are carried out by way of various computing hardware and software systems. For example, an inventory manager has been traditionally charged with the task of managing inventory levels in order to manage losses, determine when inventory is running low, and determining the optimal re-ordering frequency. Inventory tasks were typically accomplished through a physical accounting of warehoused and shelved products, for example. However, most inventory tasks are now maintained by computing systems. As barcode labels and RFID are scanned at the point of sale, the item is electronically removed from a running inventory. Therefore, inventory managers now interact with a number of applications and databases to monitor inventory level and perform related tasks. Such systems are often protected by passwords to prevent unauthorized users from accessing and/or modifying sensitive data. However, granting access to systems required to perform specific responsibilities can be a complex task. A system administrator is often required to determine who is responsible for authorizing an employee to access a system, determine what levels of access the employee should be granted, identify any possible policy infractions, and receive authorization from the identified authority prior to assigning the employee a password and configuring privileges.

To efficiently provide and manage authority, there is a need for a system and method for obtaining authorizations and managing permissions relating to program administrators. More specifically, there is a need for a system that maintains and manages contact information relating to an organization, wherein the contact information includes hierarchy data that can be used to automatically route requests for authority to the appropriate authorizing officers for review and approval. Further, such a system should enable an authorizing officer to review and/or modify permissions, which in part, controls access to various computing systems and information.

### SUMMARY OF THE INVENTION

The invention includes a system and method for facilitating the registration and management of program administrators and their assigned privileges. The system includes a contact management and registration utility that processes requests to manage one or more programs and/or products for an organization. Requests are transmitted to authorizing officers for the corporation for review and configuration. The authorizing officer may electronically approve the request, which represents a Power of Attorney giving the program administrator the legal authority to manage specific products and/or programs on behalf of the organization. The authorizing officer may also configure the permissions relating to the program administrator.

A program administrator who has been given management authority may access various program/product management systems based on their specific permissions in order to execute a variety of tasks such as, for example, requesting a corporate card for a new employee, canceling a corporate card, creating travel arrangements, and the like.

The system also includes reporting tools that enable authorizing officers, account development managers, as well as any other designated third-party to view program administrator profiles, system and account access information, hierarchical information relating to those to whom authority has been granted, etc. This information may be used, for example, to perform an efficiency analysis, an audit, or to determine when permissions should be modified.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is a block diagram illustrating the major system components for an exemplary system for managing permissions relating to programs and/or products in accordance with an exemplary embodiment of the present invention;

FIGS. 2A-2B are a process flow diagram showing exemplary steps for facilitating the registration of program administrators and assigning permissions to manage programs and/or services an behalf of an organization in accordance with an exemplary embodiment of the present invention; and,

FIG. 3 is a screenshot illustrating an exemplary interface for enabling authorizing officers, and/or any other designated party, to view and/or modify privileges relating to a program administrator in accordance with an exemplary embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. Moreover, any of the functions or steps may be outsourced to, or performed by, one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention includes a system and method for enabling the management of authority granted to members of an organization or any third party designate. As used herein, “power of attorney” or similar terms may include any authority or partial authority granted to an individual, group of individuals, or entity in order to carry out tasks relating the operations of an organization. The invention contemplates the power of attorney to be a legal instrument and/or an implicit or explicit granting of authority. The granting of authority may also be governed by corporate rules. While in one embodiment, the system is entirely paperless, those skilled in the art will appreciate that the invention also contemplates a system employing printed documents in combination with any, or all, of the disclosed power of attorney management processes.

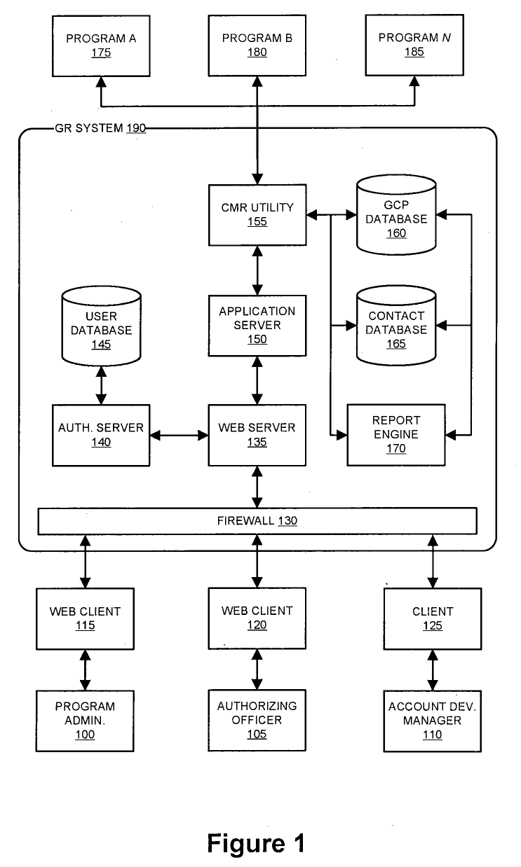

With reference to FIG. 1, the Global Registration (GR) system 190 facilitates interaction between various users (e.g., program administrator 100, authorizing officer 105, and account development manager 110) and the Contract Management & Registration (CMR) utility 110 through, in one embodiment, a web client 105, 120 with a network connection to a web server 135. In another embodiment, a client computer 125 may be equipped with an interfacing program to directly and/or indirectly interface with the various components of GR system 190 by way of a LAN, WAN, or any other known network configuration.

Web server 135 may employ an authentication server 140 in order to validate and assign proper permissions to authorized users of GR system 190. User database 145 stores credentials and permissions specific to each user. Web server 135 also employs an application server 150 to manage various applications and utilities that are utilized by GR system 190. In one embodiment, CMR utility 155 is invoked by application server 150 to query a contact database 165 and/or a Global Client Profile (GCP) database 160 to retrieve data relating to contact management, system access permissions, reporting, and the like. In one embodiment, application server 150 interfaces with a report engine 170 to create pre-configured and/or ad-hoc reports representing any data elements detailed herein.

Program administrator (PA) 100 may include any individual, business, entity, government organization, software and/or hardware, which interacts with GR system 190 to administer transaction card accounts, transaction card products, loyalty accounts, travel services, and the like. PA 100 may be, for example, an employee of a corporation who accesses CMR utility 155 to request charge cards for new employees. Moreover, PA 100 may interact with GR system 190 to enroll in the system as will be described herein in greater detail.

Authorizing Officer (AO) 105 may include any individual, business, entity, government organization, software and/or hardware, which interacts with GR system 190 to delegate a PA 100 to administer a program/product and configure permissions. AO 105 may be, for example, a Chief Financial Officer of a corporation who accesses CMR utility 155 to authorize a PA 100 to administer a corporate card account on behalf of the corporation. Moreover, AO 105 may interact with GR system 190 to configure the permissions such that the PA 100 is able to open card accounts, for example, but is not allowed to cancel card accounts.

Account Development Manager (ADM) 110 may include any individual, business, entity, government organization, software and/or hardware, which interacts with GR system 190 to modify program/product attributes on behalf of PA 100 and/or AO 105. In one embodiment, PA 100 may manage products and/or programs in an “offline” mode. For example, a PA 100 managing a corporate card account may need to request cancellation of a corporate card for an employee who is leaving the corporation. The PA 100 may place a call to ADM 110, provide authentication credentials, and request the cancellation. Based on instructions from PA 100, ADM 110 interacts with GR system 190 in order to perform the cancellation on behalf of PA 100.

Based on permissions granted to PA 100, CMR utility 155 manages PA 100 access to other internal and/or external systems. Access to such system may be necessary in order to enable PA 100 to manage products and/or programs that PA 100 has been authorized to maintain. For example, PA 100 has been authorized by AO 105 to manage program A 175. Thus, CMR utility 155 retrieves permissions data from GCP database 160, determines that PA 100 is an “account owner” of program A 175, and therefore provides access to a system for managing program A 175.

In addition to the components described above, GR system 190 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: user database 145, GCP database 160, contact database 165 as well as any number of other databases, both internal and external to GR system 190 useful in the operation of the invention as disclosed.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

In one embodiment, CMR utility 155, or any other GR system 190 component, may interact with any number of additional computing systems and databases in order to facilitate, for example, program administration, authority configuration, contact management, reporting and the like. Computing systems and databases residing outside of GR system 190 may be administered by a financial account and/or product provider or any other third party entity directly or indirectly involved in facilitating the disclosed system. Such third party entities may include program administrators, corporate officers, charge card issuers, automated clearinghouses (ACH), and the like.

As will be appreciated by one of ordinary skill in the art, the invention may be embodied as a customization of an existing system, an add-on product, upgraded software, a standalone system (e.g., kiosk), a distributed system, a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In one embodiment, GR system 190 may provide limited or restricted access for certain people or groups, such as, for example, clients, employees, or any other third party with an interest in, for example, program/product administration, delegation of authority, viewing reports, and the like. PA 100, AO 105, and ADM 110 may interface with GR system 190 via any communications protocol, device or method discussed herein or known in the art. In one embodiment, PA 100, AO 105, and ADM 110 may interact with the invention via an Internet browser at a web client 115, 120 and/or wireless device. In another embodiment, an ADM 110 may interact with the invention by way of client PC 125 with a LAN connection to the various components of GR system 190.

Web client 115, 120 comprises any hardware and/or software suitably configured to facilitate input, receipt and/or review of any information related to GR system 190 or any information discussed herein. Web client 105 may include a browser application installed on any device (e.g., personal computer), which communicates (in any manner discussed herein) with the invention via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that web client 115, 120 may or may not be in direct contact with the GR system 190. For example, web client 115, 120 may access the services of the GR system 190 through another server, which may have a direct or indirect connection to web server 135.

As those skilled in the art will appreciate, web client 115, 120 and client 125 may each include an operating system (e.g., WINDOWS NT, 95/98/2000/Vista, OS2, UNIX, LINUX, SOLARIS, MAC OS, etc.) as well as various conventional support software and drivers typically associated with computers. The web client 115, 120 and client 125 may include any suitable personal computer, network computer, workstation, minicomputer, mainframe or the like. Web client 115, 120 and client 125 can be in a home or business environment with access to a network. In an exemplary embodiment, access is through a network or the Internet through a commercially available web-browser software package.

Web client 115, 120 and client 125 may be independently, separately or collectively suitably coupled to the network via data links which includes, for example, a connection to an Internet Service Provider (ISP) as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The invention contemplates uses in association with web services, utility computing, pervasive and individualized computing, security and identity solutions, autonomic computing, commodity computing, mobility and wireless solutions, open source, service oriented architecture, biometrics, grid computing and/or mesh computing.

Web server 135 may include any hardware and/or software suitably configured to facilitate communications between web client 115, 120 and client 125 and one or more GR system 190 components. Further, web server 135 may be configured to transmit data to web client 115, 120 and client 125 within markup language documents. Web server 135 may operate as a single entity in a single geographic location or as separate computing components located together or in separate geographic locations. Requests originating from web client 115, 120 and client 125 may pass through a firewall 130 before being received and processed at web server 135. As used herein, “transmit” may include sending electronic data from one system component to another over a network connection. Additionally, as used herein, “data” may include encompassing information such as commands, queries, files, data for storage, and the like in digital or any other form. Web server 135 may provide a suitable web site or other Internet-based graphical user interface which is accessible by PA 100, AO 105, ADM 110, or any other authorized third party. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.98). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap For The Enterprise (2003), hereby incorporated by reference.

In one embodiment, firewall 130 comprises any hardware and/or software suitably configured to protect GR system 190 components from users of other networks. Firewall 130 may reside in varying configurations including Stateful Inspection, Proxy based and Packet Filtering among others. Firewall 130 may be integrated as software within web server 135, any other system component or may reside within another computing device or may take the form of a standalone hardware component.

In one embodiment, applications server 150 includes any hardware and/or software suitably configured to serve applications and data to a connected web client 115, 120 and client 125. Like web server 135, applications server 150 may communicate with any number of other servers, databases and/or components through any means discussed herein or known in the art. Further, applications server 150 may serve as a conduit between web client 115, 120 and client 125 and CMR utility 155. Web server 150 may interface with applications server 150 through any means discussed herein or known in the art including a LAN/WAN, for example. Application server 150 may further directly and or indirectly interact with authentication server 140, user database 145, GCP database 160, contact database 165, report engine 170 or any other GR system 190 component in response to web client 115, 120 and client 125 requests.

GR system 190 further includes a report engine 170. Report engine 170 includes any hardware and/or software suitably configured to produce reports from information stored in one or more databases. Report engines are commercially available and known in the art. Report engine 170 provides, for example, printed reports, web access to reports, graphs, real-time information, raw data, batch information and/or the like. Report engine 170 may be implemented through commercially available hardware and/or software, through custom hardware and/or software components, or through a combination thereof. Further, report engine 170 may reside as a standalone system within GR system 190 or as a component of web server 135.

To control access to web server 135 or any other component of the invention, web server 135 may invoke authentication server 140 in response to submission of authentication credentials received at web server 135. In one embodiment, authentication server 140 includes any hardware and/or software suitably configured to receive authentication credentials, encrypt and decrypt credentials, authenticate credentials, and/or grant access rights according to predefined privileges attached to the credentials. Authentication server 140 may grant varying degrees of application and data level access based on user information stored within user database 145.

In one embodiment, the various databases disclosed herein (e.g., user database 145, GCP database 160, and contact database 165) include any hardware and/or software suitably configured to facilitate storing authentication and/or privilege information relating to users. One skilled in the art will appreciate that the invention may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The software elements of the present invention may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts, text messages, and the like. It should be further appreciated that the multiple steps as illustrated and described may be combined into single web pages and/or interfaces but have been expanded for the sake of simplicity. In other cases, steps illustrated and described as single process steps may be separated into multiple web pages and/or interfaces but have been combined for simplicity.

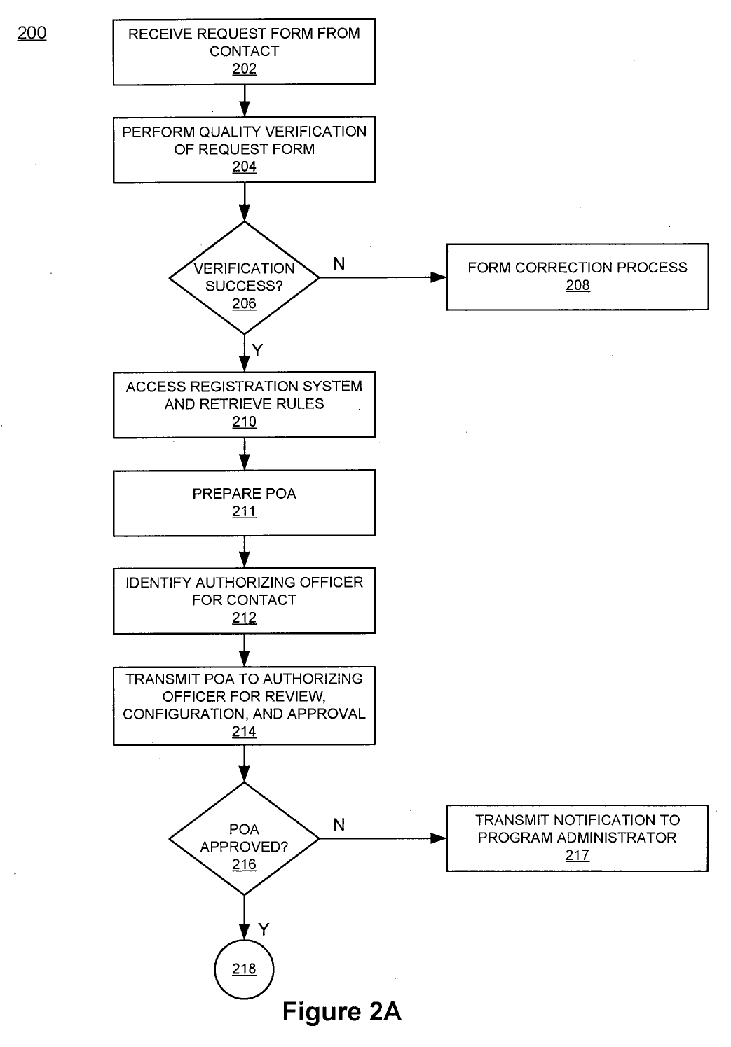

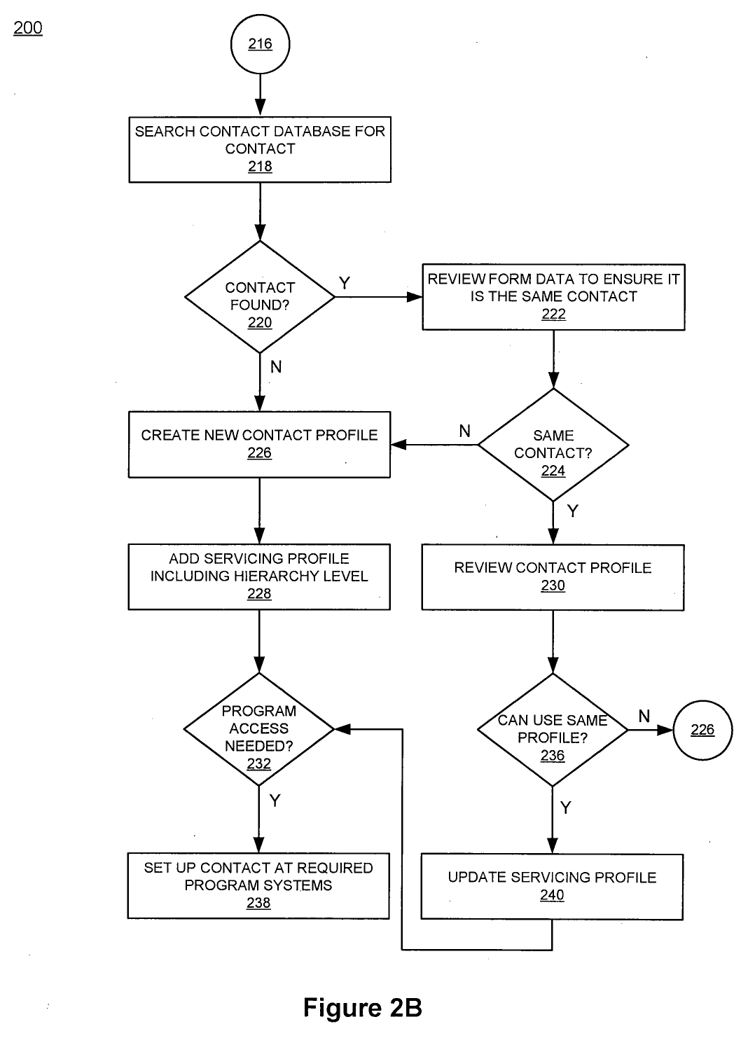

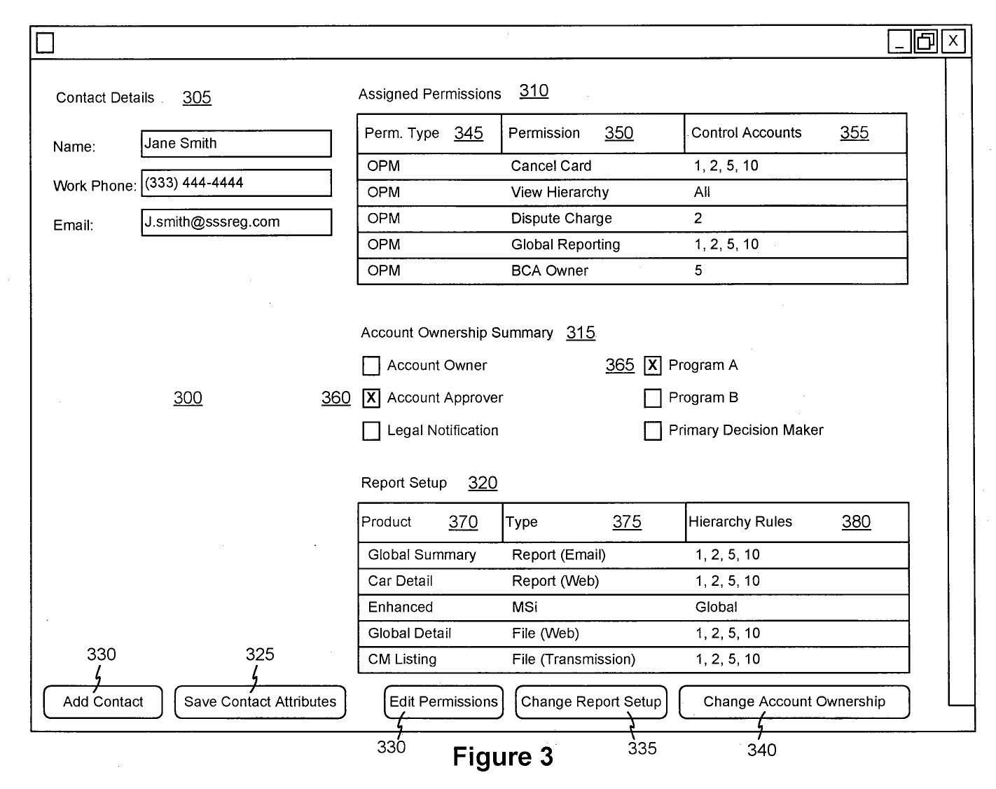

Referring now to the figures, the block system diagram and process flow diagram represent mere embodiments of the invention and are not intended to limit the scope of the invention as described herein. For example, the steps recited in FIGS. 2A-2B and 3 may be executed in any order and are not limited to the order presented. It will be appreciated that the following description makes appropriate references not only to the steps depicted in FIGS. 2A-2B and 3, but also to the various system components as described above with reference to FIG. 1.

With reference to FIG. 2A, in one embodiment, the system receives a completed enrollment request form from a program administrator who wishes, or has been instructed, to administer financial programs and/or products on behalf of a first entity (step 202). CMR utility 155 performs a quality verification of the enrollment request form (step 204) to ensure all critical fields have been correctly completed. Request form verification may include, for example, ensuring that required information has been provided, verifying data types, validating account numbers, and/or the like. If the verification step fails (step 206), then the request form is subject to further processing (step 208) to determine the nature of the problem and to identify who is responsible for making corrections. When necessary changes have been made to either the request form data, or to other systems (e.g., a control account stored in GCP database 160), the form is again subjected to a request form quality verification process (step 204).

If a form is successfully verified (step 206), form data is processed by GR system 190 (step 210) and rules a retrieved relating to PA 100 and/or financial products. Such rules govern permissions relating the management of one or more designated financial products and/or programs. CMR utility 155 prepares a POA according to the defined rules (step 211) based on terms defined by the rules. CMR utility 155 issues a query against contact management database 165 to identify the AO 105 corresponding to the PA 100 (step 212). For example, CMR utility 155 may use an account number from the form to retrieve information relating to the company, division, geographic location, and the like to identify the specific AO 105. CMR utility 155 transmits the prepared POA to the identified AO 105 for approval (step 214). In one embodiment, the AO 105 receives a notification from GR system 190 indicating that there is a POA requiring review and authorization. Notification may be by way of email, telephone, postal mail, facsimile, and the like. In another embodiment, the approval process further enables the AO 105 to configure specific permissions for the PA 100 prior to issuing an approval.

Interfacing with GR system 190 through web client 120, AO 105 reviews the terms of the POA as well as any other information pertaining to legal regulations, GR system 190 policies, and the like. Practitioners will appreciate that there are known methods for obtaining a legally binding signature electronically. For example, an electronic form may include one or more statements, whereby the AO 105 is prompted to agree or disagree with the one or more statements by selecting an “I Agree” checkbox. Furthermore, the AO 105 may be required to “sign” the electronic form by entering any combination of first name, last name, account number, social security number, security code, username, password, and/or the like. As used herein, an authorization of a POA may include a signature, a digital signature, a verbal communication, an electronic communication, a written communication, and the like.

If the AO 105 does not agree to the terms of the POA (step 216), then GR system 190 may issue a notification to the PA 100 indicating that the authorization was not approved (step 217). In one embodiment, the notification may include a specific reason that AO 105 did not agree to grant authorization of the POA. However, if the AO 105 agrees to the terms of the POA (step 216), then CMR utility 155 performs a search of contact database 165 for the contact identified within the POA (step 218). Because the PA 100 may be granted authority to manage programs and/or products for various company departments, for example, GR system 190 may avoid recording redundant contact data. If the contact is found (step 220), then CMR utility 155 reviews the form data (step 222) to ensure that it represents the same contact as one located in contact database 165. Such form data may include, for example, a business unit identifier, mailing address, employee ID number, and the like.

If CMR utility 155 confirms that the form data corresponds with a contact stored in contact database 165 (step 224), then CMR utility 155 performs a review of the contact profile (step 230). Such review may enable GR system 190 to determine whether the same contact record may be used for the PA 100 or whether a new contact record will need to be established. For example, if a PA 100 is a third-party who administers corporate charge card accounts for multiple corporations, it may be necessary to create a new contact record, even if one or more presently exist. However, practitioners will appreciate that various elements of a contact profile may be stored in two or more database tables that are linked by a primary key. Thus, while it may be necessary to create a new record in one table, in may not be necessary to create a new record in a table containing a record comprising base contact information (e.g., name, mailing address, telephone number, email address, etc.).

If CMR utility 155 determines that the identified PA 100 record can be used as the servicing profile for the PA 100 (step 236), then CMR utility 155 updates the servicing profile (step 240). The servicing profile maintains information that is required for maintaining authorities that are granted to the PA 100, as well as information useful in reporting, analysis of authority hierarchies, and the like. Therefore, if the same servicing profile is to be used for the PA 100, then the CMR utility 155 updates the profile with information relevant to the newly approved POA. If, however, CMR utility 155 determines that the same profile may not be used (step 236), then a new contact profile is created and stored in contact database 165 (step 226). Likewise, if a profile corresponding to the contact identified in the POA is not found in the contact database (step 220), then CMR utility 155 creates a new contact profile (step 226).

A new contract profile includes hierarchical information that is used by GR system 190 to identify authorizing officers and to apply appropriate rules when assigning permissions for the PA 100. For example, hierarchical information may indicate that PA1 reports directly to AO1 and manages an overall corporate card program for a corporation, while PA2 reports to PA1 and manages issuance of corporate cards to new employees. P3 manages travel for the corporation and reports to AO2. This information is used by GR system 190 to determine whether to allow, for example, PA2 to grant authority to P3.

GR system 190 combines the new contact profile along with hierarchical information to add a servicing profile to GCP database 160 (step 228). Whether GR system 190 uses contact information to update an existing servicing profile (step 240) or creates a new service profile from a contact profile (step 228), determination is made whether specific program access is needed (step 232). In order to manage a program and/or product on behalf of an organization, a PA 100 often needs access to one or more computing systems. For example, to manage a corporate charge card account, PA 100 accesses a card managements system of the card issuer. Therefore, when a new employee is hired, the PA 100 can login to the card management system to submit a request for a new corporate card with a credit limit of $5,000. When such access is needed, GR system 190 interfaces with backend systems (e.g., program A 175, program B, 180, and program N 185) to establish an account for the PA 100 with access privileges (step 238).

With reference to FIG. 3, AO 105 may interact with GR system 190 through a web client 115 interface to view and/or modify contact information and permissions relating to a PA 100. In one embodiment, other parties may also be provided access to the interface illustrated in FIG. 3. As previously described, a PA 100 may be given permission to delegate authority to another PA. As such, the interface may be used by any party designated by an organizational hierarchy, AO 105, account development manager 110, and/or any combination thereof to view and manage permissions. For the purpose of discussion, “PA 105” will be used in reference to FIG. 3; however, it should be noted that such interaction is not limited to PA 105 alone. Practitioners will appreciate that the various fields of the interface illustrated in FIG. 3 may be modified without departing from the scope of the invention. For example, the invention may incorporate any number of screens, web pages, and the like to encompass the utility of the interface as described herein. Furthermore, such an interface may include more or less information than what is illustrated in FIG. 3.

PA 105 may access CMR utility 155 through web client 120 to interact with the permission interface 300. Permission interface 300 includes various fields and tables for viewing contact details 305, assigned permissions 310, account ownership 315, and report setup 320. To retrieve such information pertaining to a particular PA 100, AO 105 may select the PA 100 name from a dropdown menu, for example, or perform a search based on name, organization name, role, business unit, AO 105 name, and the like.

Interface 300 is populated with information relating to a selected PA 100 as represented in contact database 165 and GCP database 160. In one embodiment, contact details 305 may include global hierarchy information that is displayed graphically or within a table. Other contact details 305 may include, for example, company name, position title, mailing address, supervisor name, and the like. PA 105 may modify or add contact details 305 relating to an existing profile and then save the changes to contact database 165 by selecting a “Save Contact Attributes” button or link 325. Moreover, a new contact may be added through the interface 300 under predefined scenarios where the process steps (as discussed in relation to FIGS. 2A-2B) are either not appropriate or not needed. For example, in order to add contact information for AO 105, a process to obtain an authorization and assignment of permissions may not be necessary, as the PA is in a position to delegate authority. However, practitioners will appreciate that certain scenarios may call for an AO 105 to be registered with the GR system 190 through the disclosed process steps. To create a new contact, AO 105 may select an “Add Contact” link or button 330 within interface 300 to create new records in GCP database 160 and contact database 165. AO 105 may enter the appropriate contact details 305 and configure permissions 330, account ownership 340, and report setup 335 as will be disclosed in further detail herein. Selecting the “Save Contact Attributes” link or button 325 commits the entered information to the appropriate database tables.

The assigned permission 310 for the PA 100 may be displayed in a table for more convenient viewing. The table includes columns for displaying permission type 345, permission description 350, and control account 355. The control account 355 refers to a primary account for an organization that is serviced by one or more PAs. Because the system enables a single PA 100 to manage programs and/or products on behalf of multiple organizations, GR system 190 references these organizations by control account numbers. In one embodiment, for example, GR system 190 enables users to access all of the PAs for a particular organization by entering a control account number corresponding to the organization.

In one embodiment, AO 105 may modify the assigned permissions 210 from directly within interface 300. For example, AO 105 may place a mouse cursor into the first cell of the control accounts column 355 and delete control account “10” from the list of account numbers. AO 105 may commit the table changes to the appropriate database records by selecting a link or button 330. In another embodiment, assigned permissions for the PA 100 may be modified by first selecting an “Edit Permissions” link or button 330, which invokes GR system 190 to retrieve the assigned permissions for the PA 100, populate editable fields within a second interface, and present the second interface to the AO 105. The second interface may include fields, check boxes, dropdown menus, and the like in order to enable the AO 105 to modify, add, or delete values relating to assigned permissions.

The account ownership summary 315 displays the specific role that the PA 100 has been assigned relative to the assigned permissions 210. For example, the PA 100 may be an account approver 360 for program A 365. As such, the assigned permissions may be more limited than those assigned to the account owner. Account ownership may be modified by selecting the boxes corresponding to the description in order to select or deselect the particular account and/or account role. In another embodiment, AO 105 may select a “Change Account Ownership” link or button 340, which invokes GR system 190 to retrieve the account ownership information for the PA 100, populate editable fields within a second interface, and present the second interface to the AO 105. The second interface may include fields, check boxes, dropdown menus, and the like in order to enable the AO 105 to modify, add, or delete values relating to account ownership.

The report setup 320 table displays details regarding specific reports which are accessible by selected PA 100. The “Product” column 370 lists the reports relating to the accounts that PA 100 has been granted management authority. The “Type” column 375 specifies the report type (e.g., “report” and “file”) and delivery mechanism. For example, GR system 190 may be configured to automatically run a report and send it as an email attachment to an authorized PA 100. In another embodiment, GR system 190 generates a report and stores it at web server for online access. Accordingly, GR system 190 may generate an email notification regarding the availability of a report to an authorized PA 100. The email content may include a link to web server where PA 100 may login and view the report. Likewise, data relating to programs and/or products may be compiled and stored as data files that are made available by way of the Internet, or transmitted via File Transfer Protocol (FTP), or any other networking technology, to a web client.

The “Hierarchy Rules” column 380 relates to the level of access that PA 100 has been delegated for each available report. Similar to other modifications to PA 100 authority, changing the hierarchy rules may affect all other PAs that are lower in the modified PA's 100 hierarchy. For example, a PA1 is granted access to a “Global Summary” report. PA1 then delegates global (unrestricted) access to PA2, which subsequently delegates global access to the PA3. Later, PA1 modifies the report setup to limit access to sections 1, 2, and 5 of the report to the PA2. This change to PA2 automatically affects the access granted to PA3, because PA2 is now limited to authorizing access to sections 1, 2, and 5 of the report, rather than the previous “full” access.

In one embodiment, AO 105 may modify the report setup 320 from directly within interface 300. For example, AO 105 places a mouse cursor into the first cell of the “Type” column 355 and selects a different report type from a dropdown menu. AO 105 may commit the table changes to the appropriate database records by selecting a link or button 335. In another embodiment, report setup 320 for the PA 100 may be modified by first selecting an “Change Report Setup” link or button 335, which invokes GR system 190 to retrieve the report setup data for the PA 100, populate editable fields within a second interface, and present the second interface to the AO 105. The second interface may include fields, check boxes, dropdown menus, and the like in order to enable the AO 105 to modify, add, or delete values relating to report setup.

In one embodiment, AO 105 may modify the reports that PA 100 is authorized to receive/view from directly within interface 300. For example, when AO 10S places a mouse cursor into the first cell of the “type” column 375, a dropdown menu populated with available “type” values is displayed, enabling the PA 100 to select a new “type” value for the corresponding product. PA 100 may commit the table changes to the appropriate database records by selecting a link or button 335. In another embodiment, reports available to the PA 100 may be modified by first selecting a “Change Report Setup” link or button 335, which invokes GR system 190 to retrieve details relating to PA 100 authorized reports, populate editable fields within a second interface, and present the second interface to the AO 105. The second interface may include fields, check boxes, dropdown menus, and the like in order to enable the AO 105 to modify, add, or delete values relating to reports.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

We claim:

1. A computer-implemented method for maintaining program management user privileges, said method comprising:
receiving a request from a first user, wherein said request is indicative of a desire for said first user to manage a financial product, and wherein said first user is eligible to manage said financial product;
retrieving rules related to at least one of: said user and said financial product;
preparing a power of attorney in accordance with said rules, wherein said rules are used to define terms of said power of attorney;
transmitting said power of attorney to a second user for review;
receiving an authorization of said power of attorney from said second user; and,
enabling management by said first user of said financial product, wherein said management of said financial product is governed by said terms of said power of attorney.

2. The method of claim 1, wherein said financial product includes at least one of: a charge account, credit account, a debit card account, a loyalty account, and a financial service.

3. The method of claim 1, wherein said first user is a program administer.

4. The method of claim 1, wherein said step of receiving an authorization of said power of attorney comprises a signature, a digital signature, a verbal communication, an electronic communication, and a written communication.

5. The method of claim 1, further comprising determining when said first user is eligible to manage said financial product.

6. The method of claim 1, wherein said rules include at least one of: permissions and restrictions relating to said management of said financial product.

7. The method of claim 1, wherein said step of enabling said first user to manage said financial product comprises managing said financial product in more than one country.

8. The method of claim 1, wherein said power of attorney may be modified by at least one of: said first user and said second user.

9. The method of claim 1, further comprising:
receiving first user information including contact information for said first user;
storing said first user information in a first user profile;
receiving second user information including contact information for said second user; and,
storing said second user information in a second user profile.

10. The method of claim 9, wherein said first user profile and said second user profile includes at least one of: address, phone number, email address, language preferences, time zone, mail preferences, opt-in, opt-out, and personal preferences.

11. The method of claim 1, further comprising maintaining history information relating to said management of said financial product.

12. The method of claim 1, further comprising viewing, by said second user, of said power of attorney by way of at least one of: online and physical report.

13. The method of claim 1, wherein said step of enabling said first user to manage said financial product is facilitated by way of at least one of: web interface, telephone, personal instruction, email, facsimile, and text message.

14. The method of claim 1, further comprising revoking said terms of said power of attorney at a predetermined time.

15. The method of claim 1, further comprising at least one of: defining and modifying, by said second user, said terms of said power of attorney prior to said authorization.

16. The method of claim 1, further comprising defining said rules by said second user.

17. The method of claim 1, further comprising formatting said power of attorney in a different language.

18. The method of claim 1, further comprising transmitting said power of attorney to a third user for review, and receiving an authorization of said power of attorney from said third user.

19. The method of claim 1, wherein said authorization includes a digital certificate.

20. The method of claim 1, wherein said step of preparing said power of attorney comprises at least one of: formatting said power of attorney based on a template power of attorney, editing an existing power of attorney, and creating a new power of attorney.

21. A system for maintaining program management user privileges, said system comprising:
a registration utility configured to receive a request from a first user, wherein said first user is eligible to manage a financial product, and wherein said request is indicative of a desire for said first user to manage said financial product;
said registration utility further configured to retrieve rules applying to at least one of: said user and said financial product in order to prepare a power of attorney in accordance with said rules, wherein said rules are used to define terms of said power of attorney;
a web server configured to transmit said power of attorney to a second user for review in order to receive an authorization of said power of attorney from said second user; and,
said registration utility further configured to enable said first user to manage said financial product upon said authorization by said second user, wherein said management of said financial product is governed by said terms of said power of attorney.

22. The system of claim 21, wherein said registration utility is further configured to receive first user information including contact information for said first user, wherein said first user information is stored in a first user profile.

23. The system of claim 21, wherein said registration utility is further configured to receive second user information including contact information for said second user, wherein said second user information is stored in a second user profile.

24. The system of claim 21, wherein said first user is a program administer.

25. The system of claim 21, wherein said registration utility is configured to receive a request from said second user to provide said power of attorney to a third user.

26. The method of claim 21, wherein said rules include at least one of: permissions and restrictions relating to said management of said financial product.

27. A computer readable storage medium containing a set of instructions for a general purpose computer for maintaining program management user privileges, said instructions performing the steps of:
receiving a request from a first user, wherein said request is indicative of a desire for said first user to manage a financial product, and wherein said first user is eligible to manage said financial product;
retrieving rules related to at least one of: said user and said financial product;
preparing a power of attorney in accordance with said rules, wherein said rules are used to define terms of said power of attorney;
transmitting said power of attorney to a second user for review;
receiving an authorization of said power of attorney from said second user; and,
enabling management by said first user of said financial product, wherein said management of said financial product is governed by said terms of said power of attorney.
